(19) United States
(12) Patent Application Publication
(10) Pub. No.: US 2010/0289268 A1
(43) Pub. Date: Nov. 18, 2010

(54) UNDERWATER TURBINE

(76) Inventor: Helmut Schiller, Lorsch (DE)

Correspondence Address: LONDA, BRUCE S.;NORRIS MCLAUGHLIN & MARCUS, PA, 875 THIRD AVE, 8TH FLOOR, NEW YORK, NY, 10022, US

(21) Appl. No.: 12/747,410

(22) PCT Filed: Dec. 4, 2008
(86) PCT No.: PCT/EP08/10252

§ 371 Date: Jul. 21, 2010

(30) Foreign Application Priority Data
Dec. 13, 2007 (DE) 202007017544.2

(51) Int. Cl. H02K 7/18

(52) U.S. Cl. 290/54

(57) ABSTRACT

The invention relates to an underwater turbine (10) for converting flow energy from water, for example water flowing in brooks, rivers or tidal and/or ocean currents, into mechanical and/or electrical energy, wherein the outlet of a ducted turbine (12) which is flown through by flowing water is disposed in the area where the cross section of a Venturi nozzle arrangement (20) or the like is narrowest. The turbine (12) is preferably designed as an axial turbine, but also turbines having a different design, for example radial turbines, are suitable.

The invention relates to an underwater turbine for converting flow energy from water, for example water flowing in brooks, rivers or tidal and/or ocean currents, into mechanical and/or electrical energy.

Turbines are known with a housing and Venturi inlet in order to increase the mass flow through the turbine and the flow rate on the turbine wheel in order to achieve a higher energy yield from the existing turbine wheel.

The object of the invention is to significantly increase the achievable output of the known turbines cost-effectively with the least possible outlay on design or apparatus.

This object is achieved according to the invention in that the outlet of a shrouded turbine through which flowing water flows is disposed in the region of a Venturi nozzle arrangement with the narrowest cross-section. The water for the Venturi nozzle arrangement does not have to flow through the turbine and can be accelerated to the maximum without allowing an excessively high dynamic pressure to be produced at the inlet of the Venturi nozzle arrangement.

Accordingly the pressure in the narrowest cross-section of the Venturi nozzle arrangement is lower than behind the turbine wheel and draws off the turbine water. This increases the pressure differential before and behind the turbine wheel, which results in a greater flow through the turbine and energy extraction.

Due to the increase in the flow rate of the water in the turbine, this turbine can also be used in slow-flowing stretches of water.

The Venturi nozzle arrangement may be disposed so that with a circular cross-section it concentrically surrounds the turbine housing of the shrouded turbine or projects laterally on one side or—preferably—from two diametrically opposing sides of the turbine housing of the shrouded turbine, whereby the structural height of the underwater turbine can be reduced by comparison with a Venturi nozzle arrangement constructed with a circular cross-section concentrically with the turbine housing. Due to the shallow design thus obtained, the turbine can then be used in stretches of water with a correspondingly low water level.

The shrouded turbine of the underwater turbine is preferably constructed as an axial turbine, although in principle other turbine constructions, for example radial turbines, are suitable.

In the case of an axial turbine it is recommended to provide the turbine wheel with an outer shroud.

As a result it is then possible in an advantageous alternative embodiment of the invention to dispose the outer shroud of the turbine wheel in an annular section of the turbine housing which has an enlarged diameter relative to the internal diameter of the turbine housing, whereby it is also possible to dispose sealing means preferably constructed as a contactless labyrinth seal between the outer circumferential surface of the shroud and the section of the turbine housing with the enlarged diameter.

At least one baffle wall like a guide vane extending in the water outflow direction is then advantageously provided in the region of the Venturi nozzle arrangement on the flow outlet side in order to substantially avoid the turbulence of the emerging flow of water.

Alternatively the shrouded turbine can be provided with a gearless generator or can be provided, by way of an interposed gear, with a generator.

The generator is preferably a generator which supplies electrical energy.

By using the electrical current supplied by the generator for electrolytic decomposition of water the generator can be modified to a hydrogen generator.

The underwater turbine can be disposed rotatably and/or pivotably on a mounting, e.g. on the upper end of a mast-like support, the lower end of which is retained on a prefabricated base on the bed of the stretch of flowing water.

In this case it is also possible for two underwater turbines driven in opposing directions to be disposed on the upper end of the mast-like support.

An alternative possibility is the floating arrangement on a floating pontoon, or on a buoyancy body which is provided in the water and is fixed with adjustable retaining means (cables) on the bed and thus can orient itself according to the flow direction.

The entire turbine can be pivoted out of the horizontal orientation by the adjustment of the anchoring device in order to make optimum use of rising or falling levels of the flowing water.

The invention is explained in greater detail in connection with the drawings relating to two embodiments, in which:

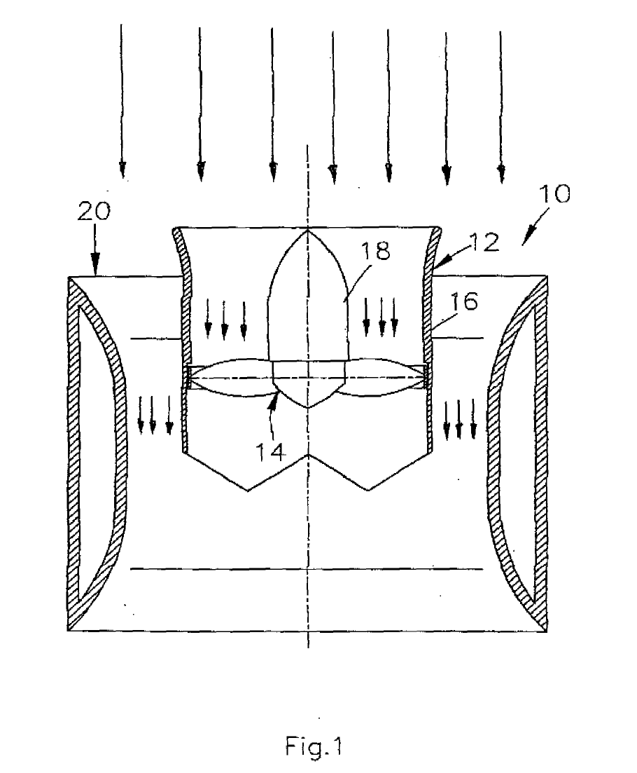

FIG. 1 shows a schematic representation of a longitudinal central section through a first embodiment of an underwater turbine constructed according to the invention, and

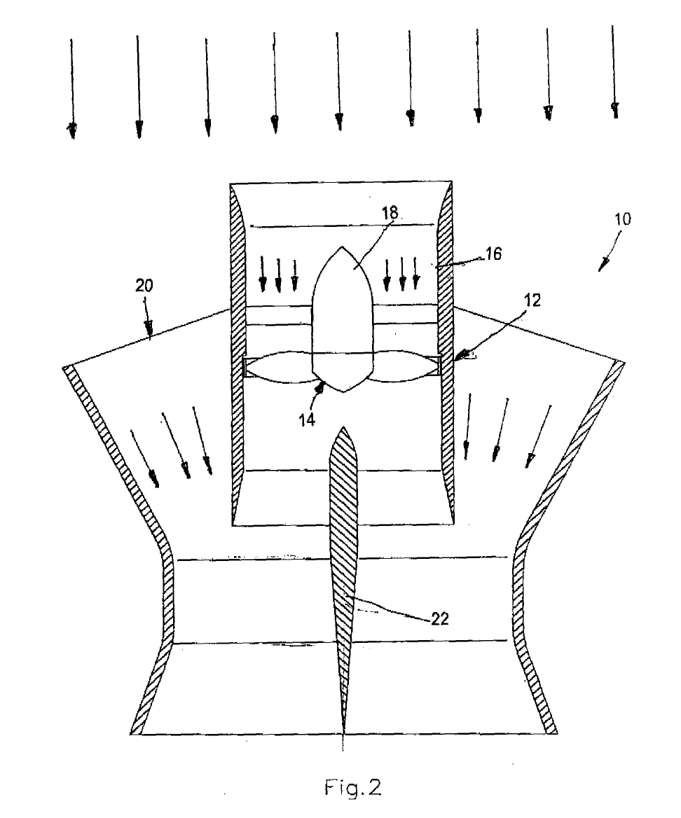

FIG. 2 shows a second modified embodiment of the underwater turbine in a representation corresponding to FIG. 1.

The embodiment of an underwater turbine according to the invention which is illustrated in FIG. 1 and denoted in its entirety by 10 has an inner axial turbine constructed as a shrouded turbine 12 of which the turbine wheel 14 is connected so as to be fixed against rotation to the shaft of a generator 18—in the illustrated case an electrical generator—which is disposed centrally in the turbine housing 15.

The shrouded turbine 12 is disposed in the region of the narrowest cross-section of a Venturi nozzle arrangement 20 which surrounds it. Thus a part-quantity of the water flowing in from above in the downward direction in the drawing flows through the axial turbine in the central region, whereby the turbine wheel 14 and the shaft of the generator 18 connected thereto so as to be fixed against rotation are driven and electrical energy is produced.

A second part-quantity flows through the space formed between the interior of the Venturi nozzle arrangement 20 and the shrouded turbine 12, whereby in the region of the narrowest cross-section of the Venturi nozzle arrangement a central part-quantity of the flow flowing off from the axial turbine is combined with the second part-quantity of the flow which surrounds it concentrically. Due to the pressure which is thereby reduced at the turbine outlet the pressure drop between the turbine inlet and outlet is enhanced and thus the turbine output is increased.

The embodiment of the underwater turbine 10 according to the invention which is shown in FIG. 2 corresponds in function and basic construction to the embodiment described above in connection with FIG. 1, where functionally identical components in the two embodiments in the drawings are also allocated the same reference numerals, so that in order to avoid repetitions it is sufficient if only the amendments or additions which are made relative to the first embodiment are described, whilst reference can be made moreover to the preceding description.

In contrast to the first embodiment, the Venturi nozzle arrangement 20 in the second embodiment does not have a circular cross-section but is deformed in cross-section to an oval shape, so that on opposing sides of the turbine housing 16 of the shrouded turbine 12 two partially or completely separate flow chambers are formed for the outer part-quantities of the flow flowing through the Venturi nozzle arrangement. In order to prevent the production of energy-absorbing turbulence in the total flow quantity flowing out due to the radial components of the outer part-quantity or part-quantities of the flow, a baffle wall 22 like a guide vane extending in the longitudinal central direction of the underwater turbine is provided on the outlet side and is also guided a little way into the outlet side of the turbine housing 16 of the shrouded turbine 12 and passes radially through the outlet side of the Venturi nozzle arrangement.

1. Underwater turbine (10) for converting flow energy from water for example water flowing in brooks, rivers or tidal and/or ocean currents, into mechanical and/or electrical energy, wherein the outlet of a shrouded turbine (12) through which flowing water flows is disposed in the region of a Venturi nozzle arrangement (20) or the like with the narrowest cross-section.

2. Underwater turbine as claimed in claim 1, wherein the Venturi nozzle arrangement (20) is disposed so that with a circular cross-section it concentrically surrounds the turbine housing (16) of the shrouded turbine (16).

3. Underwater turbine as claimed in claim 1, wherein that the Venturi nozzle arrangement (20) projects laterally on one side or—preferably—from two diametrically opposing sides of the turbine housing (16) of the shrouded turbine (12).

4. Underwater turbine as claimed in claim 1, wherein it is an axial turbine.

5. Underwater turbine as claimed in claim 1, wherein it is a radial turbine.

6. Underwater turbine as claimed in claim 4, wherein the turbine wheel (14) is provided with an outer shroud.

7. Underwater turbine as claimed in claim 6, wherein the outer shroud of the turbine wheel (14) is disposed in an annular section of the turbine housing (16) which has an enlarged diameter relative to the internal diameter of the turbine housing (16).

8. Underwater turbine as claimed in claim 7, wherein sealing means preferably constructed as a labyrinth seal are provided between the outer circumferential surface of the shroud and the section of the turbine housing (16) with the enlarged diameter.

9. Underwater turbine as claimed in claim 4, wherein at least one baffle wall (22) like a guide vane extending in the water outflow direction is provided in the region of the Venturi nozzle arrangement (20) on the flow outlet side in order to substantially avoid the turbulence of the emerging flow of water.

10. Underwater turbine as claimed in claim 1, wherein the turbine (12) is provided with a gearless generator (18).

11. Underwater turbine as claimed in claim 1, wherein the turbine (12) is provided with a gear and generator (18) etc.

12. Underwater turbine as claimed in claim 10, wherein the generator is a generator which supplies electrical energy.

13. Underwater turbine as claimed in claim 10, wherein the generator is a generator supplying hydrogen by electrolytic decomposition of water.

14. Underwater turbine as claimed in claim 1, wherein the arrangement on the upper end of a mast-like support, the lower end of which is retained on a prefabricated base.

15. Underwater turbine as claimed in claim 14, wherein two underwater turbines driven in opposing directions are provided on the upper end of the mast-like support.
